(19) United States
(12) Patent Application Publication
(10) Pub. No.: US 2016/0182282 A1
(43) Pub. Date: Jun. 23, 2016

(54) Mainframe desktop direct

(71) Applicant: Michael Lewis Moravitz, Fairfax, VA (US)

(72) Inventor: Michael Lewis Moravitz, Fairfax, VA (US)

(21) Appl. No.: 14/998,526

(22) Filed: Jan. 19, 2016

(51) Int. Cl. H04L 12/24

(52) U.S. Cl. CPC H04L 41/083

(57) ABSTRACT

Patent for streamlining, simplifying, and more directly connecting sub-units to mainframe computers to increase computing speeds.

Mainframe computers have sub-units, sometimes, called heaters, but I believe they are unnecessary and are actually holding back computing speeds.

Why store part of the desktop of an individual locally and part in the mainframe memory? In fact, with high-speed cables and increased memory capacity connecting to and in the mainframe the sub-units can be radically simplified. Instead, they could hold only what is needed for portable memory and other plug-ins. The time is now to reinvent mainframe computers without localized memory except for what is needed to plug-in by the individual user, as well as the screen, keyboard, mouse, speakers, etc.

1) Builds on Patents for Mainframe Computers with Sub-units (heaters).
